(19) United States
(12) Patent Application Publication
(10) Pub. No.: US 2011/0141020 A1
(43) Pub. Date: Jun. 16, 2011

(54) OPTICAL NAVIGATION DEVICE

(75) Inventor: Jeffrey M. RAYNOR, Edinburgh (GB)

(73) Assignee: STMicroelectronics (Research & Development) Limited, Marlow - Buckinghamshire (GB)

(21) Appl. No.: 12/900,047

(22) Filed: Oct. 7, 2010

(30) Foreign Application Priority Data
Dec. 10, 2009 (GB) 0921642.5

(51) Int. Cl. G06F 3/033

(52) U.S. Cl. 345/166

(57) ABSTRACT

A pointing device includes a light source which is detected to determine the motion of the pointing device. The pointing device further includes a sensor which is adapted to detect light from the light source in one type of operation to thereby determine the motion and which is adapted to detect ambient light in a second type of operation.

### FIELD OF THE INVENTION

The present invention relates to an optical navigation device, and, more particularly, but not exclusively to an optical navigation device including an ambient light sensor.

### BACKGROUND OF THE INVENTION

An ambient light sensor associated with a mobile phone, such as a smart phone would provide a number of advantages and functionality which could be used in a number of different applications. Ambient light sensors are widely available, but if they are to be added to a phone, it may require the addition of a hole through which light can enter to reach a sensor and that is aesthetically unpleasing. Also, the addition of an ambient light sensor adds cost to the device, which may not be justified for all applications.

Many portable devices (e.g. mobile phones) have incorporated an image sensor. In theory, this device could be used to provide information on the ambient light levels, however there are many practical problems. First, it is usually pointing in the opposite direction to the screen and so does not receive the same level of ambient light. Further, these devices have many pixels and often complicated signal processing circuitry to decode color, perform defect correction etc. resulting in a larger amount of power to operate (50 mW typical) compared to 1 mW for an optical mouse. Also, as these sensors have a large number of pixels it is computationally expensive to process them all. Finally, their sensors are usually color (e.g. Bayer pattern—U.S. Pat. No. 3,971,065) with different sensitivities for the red, green and blue which requires additional processing to obtain only the brightness information. For these reasons, the use of a standard, mega-pixel type image sensor may not be appropriate for measuring ambient light levels in a mobile device.

Most optical navigation devices (e.g. an optical mouse) have constant illumination and accordingly any light sensor associated with such a mouse would not be able to distinguish which illumination originates from the illumination source of the mouse and would thus be unable to determine the difference between the illumination source and an ambient light level.

Other types of optical mice use a pulsed illumination source. These can be used to cancel the effects due to pixel-pixel mismatch in the manufacturing process, such as is described in U.S. Pat. No. 7,502,061, for example. In these types of mice, the dark calibration period is as short as possible so that the sampling rate of the mouse can be as fast as possible. As with other optical mice the sensor of this type of optical mouse is shielded from ambient light by nature of the design.

Mobile telephones can also be provided with touch pads which translate the motion of a finger over the pad into motion of a cursor on a screen. One type of touch pad is an optical touch pad, known colloquially as a finger mouse. An optical touch pad functions in a fashion similar to an optical computer mouse. An illumination source is provided that shines upwards from the body of the mobile phone onto an underside surface of the touch pad. An image sensor is also provided to detect light reflected from the underside of the touch pad. As a finger is moved over the touch pad image analysis is carried out to detect motion and translate that to movement of a cursor or a pointer on the display screen of the mobile device. The image analysis could detect the relative position of a finger as it moves across the pad, or it could detect the relative position of ridges of skin of the finger as it moves, or features of other items such as gloves.

### SUMMARY OF THE INVENTION

It is an object of the present invention to overcome at least some of the problems associated with the prior art. It is a further object of the present invention to integrate an ambient light sensor with an optical navigation device in a cost effective aesthetically pleasing manner.

According to one aspect of the present invention there is provided a pointing device of the type including a light source which is detected to determine the motion of the pointing device, wherein the pointing device further includes a sensor which is adapted to detect light from the light source in one type of operation to thereby determine the motion and which is adapted to detect ambient light in a second type of operation.

Optionally, in the second type of operation the light source is disabled and the sensor measures ambient light conditions over a predetermined time period.

Optionally, the second type of operation further comprises a reset cycle, a calibration cycle, an exposure cycle, during which the sensor detects the ambient light conditions; and a readout cycle.

Optionally, the time period of the exposure cycle is between a factor of a hundred to a thousand times greater than a time period of the combination of other cycles. Optionally, the time period of the exposure cycle is an integer multiple of an integration period of the sensor.

Optionally, the pointing device is arranged to determine, upon a request for operation in the second type of operation, whether the device is already in use in the first type of operation, and if so, to prevent switching to the second type of operation. Optionally, the pointing device is arranged to repeat the determination until either it is determined that the device is not in use in the first type of operation in which case the second type of operation will be initiated, or until the determination has been repeated a predetermined number of times. Optionally, the pointing device is in the form of an optical mouse.

According to another aspect there is provided a device including the pointing device of the first aspect. The device may be a telephone or a computer.

According to a further aspect there is provided a method of operating a pointing device in a first and second type of operation, wherein the pointing device is of the type including a light source which is detected to determine the motion of the pointing device, and wherein the pointing device further includes a sensor, the method comprising: detecting light from the light source in the first type of operation to thereby determine the motion of the pointing device; and disabling the light source and detecting ambient light in the second type of operation to determine ambient light levels.

Optionally, the second type of operation comprises performing a reset cycle, a calibration cycle, an exposure cycle, during which the sensor detects the ambient light conditions; and a readout cycle. Optionally, the time period of the exposure cycle is between a factor of a hundred to a thousand times greater than a time period of the combination of other cycles. Optionally, the time period of the exposure cycle is an integer multiple of an integration period of the sensor.

Optionally, the method comprises requesting the second type of operation; and upon the request, determining whether the device is already in use in the first type of operation, and if so, preventing switching to the second type of operation. Optionally, the step of determining is repeated until either it is determined that the device is not in use in the first type of operation in which case the second type of operation will be initiated, or until the determination has been repeated a predetermined number of times.

The present invention offers a number of benefits. The present invention allows integration of a light sensor with an optical navigation device which does not add to manufacturing costs. In addition, there is no requirement to make a hole in the case of the telephone or other device to enable light, to reach the sensor. This of course saves further processing costs and does not make the device look unseemly.

### BRIEF DESCRIPTION OF THE DRAWINGS

Reference will now be made, by way of example, to the accompanying drawings, in which:

FIG. 1 is a block diagram of a mouse circuit, in accordance with an embodiment of the invention;

FIG. 2 is a timing diagram of a sensor operation, in accordance with an embodiment of the invention;

FIG. 3 is a timing diagram for showing multiple cycles to prevent pixel saturation, in accordance with an embodiment of the invention; and

FIG. 4 is a timing diagram for showing multiple cycles with one calibration cycle, in accordance with an embodiment of the invention.

### DETAILED DESCRIPTION OF THE PREFERRED EMBODIMENTS

The present invention relates to an optical navigation device such as a mouse which incorporates an ambient light sensor.

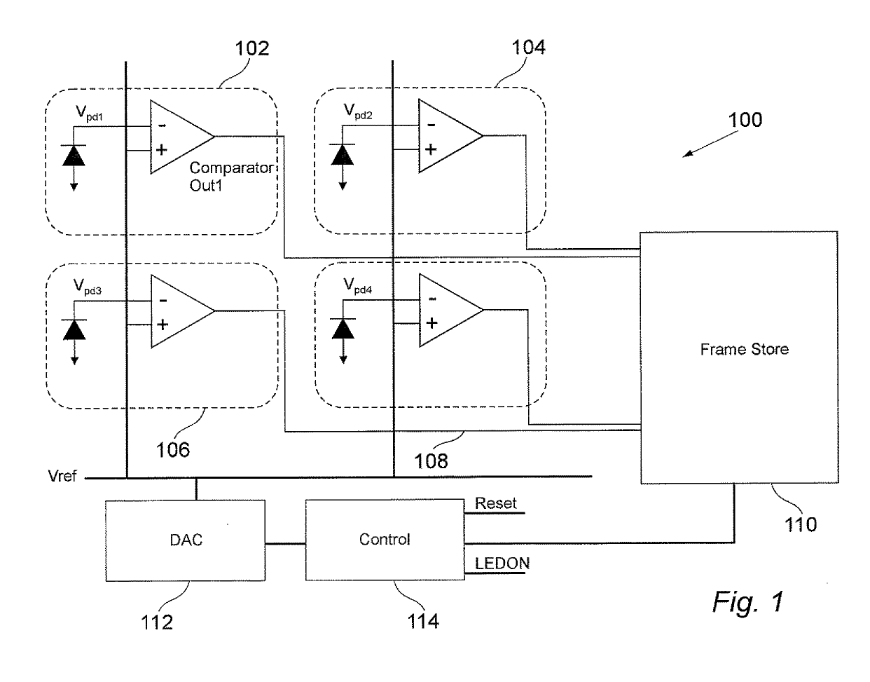

Referring to FIG. 1 a block diagram of a mouse circuit 100 is shown. For clarity of illustration, the diagram shows four amplifier and photo-diode arrangements 102, 104, 106 and 108 although it will be appreciated that a typical array may have more pixels than this. For example, real arrays may have 18×18; 20×20; 25×25 or 30×30 pixels, with perhaps higher numbers in future designs. The circuit also includes a frame store module 110, a digital to analog converter 112 and control circuitry 114.

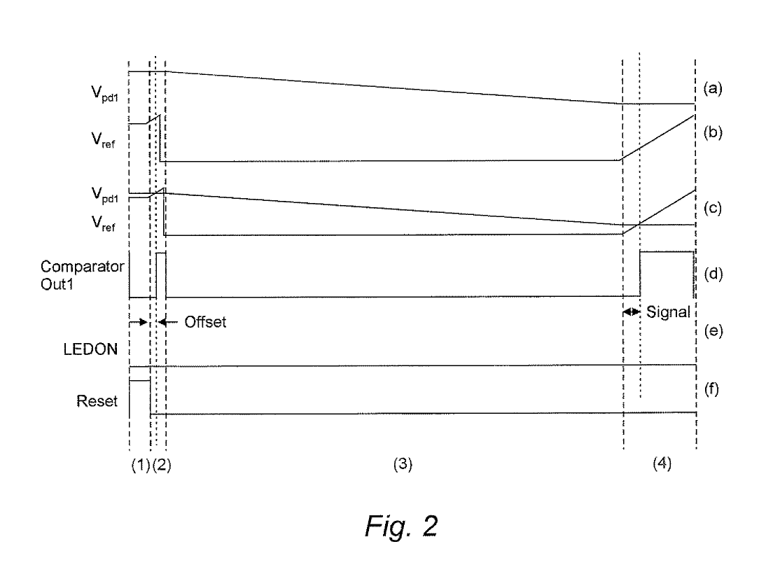

The control circuitry 114 includes outputs for reset and for switching on an LED (LEDON). Control circuit 114 provides timing signals necessary for operation of the image sensor of the optical mouse. It provides a reset pulse which occurs at the start of each frame. Typically this pulse is of constant width (10 μs-50 μs) depending on the frame rate and readout speed of the frame store 110) and preferably this reset pulse is at regular intervals—typically 1 KHz to 10 KHz. See FIG. 2, Phase (1), & (f) “Reset”. Desirably, after the pixels are reset there is a calibration phase where the voltage on the photodiode is measured. The control circuit 114 outputs signals to the ADC to measure the voltage and also outputs a signal that the data is the black reference data and not exposed pixel data, to either the framestore 110 or the image processing circuitry. See FIG. 2, Phase 2.

After the calibration phase there is an exposure phase where the LED is turned on to illuminate the surface (finger, desk, mouse-mat etc.). An automatic exposure system can be provided which monitors the output from the pixels and adjusts either the current to the LED or the period the LED is illuminated for. If there is a dark surface, the LED needs to emit more photons and if the surface is light or reflective, the LED needs to emit fewer photons to prevent the pixel from becoming saturated. Typically, the decision of LED on period is made using a complex algorithm and may not be incorporated inside the control block. In this case, the period for the LED on pulse is signaled to the control block and the control block is responsible for the LEDON signal becoming active and disabled at the appropriate times. See FIG. 2, Phase 3.

After the exposure phase of the pixel the voltage on the photodiode is measured. The control circuit 114 outputs signals to the ADC to measure the voltage and also outputs a signal that the data is the exposed pixel data (and not the black reference data), to either the framestore 110 or the image processing circuitry. See FIG. 2, Phase 4.

In some architectures, the frame-store 110 will be “dual ported”, i.e. have simultaneous access by the pixel ADC and the image processing (navigation) algorithm. A dual ported memory is more complex and therefore more expensive so typically frame-store 110 is “signal ported” and the control circuit 114 will alternate access between the ADC and image data. Typically, after the image data is output by the ADC into the frame store, the control circuit 114 will access the frame store in a sequential manner (usually “raster scan”) and the data becomes available to the image processing algorithm.

Referring now to FIG. 2, the timing diagram of the mouse in accordance with the present invention is shown. The timing diagram includes four main phases. The first phase is a reset phase (Phase 1) where all pixels are reset. At the same time the photodiodes are connected to a reference voltage (Vref) via a switch. In the second phase (Phase 2) an offset calibration occurs where the voltage on each photodiode (Vpd1, Vpd2, Vpd3 and Vpd4) is measured. The third phase (Phase 3) is an exposure phase in which the LEDON signal is in-active so that the LED is turned off. In normal mouse circuits this time delay is kept to a minimum and the LED is on, as previously indicated. The short time delay of the prior art ensures that the frame rate of the optical mouse is not detrimentally impacted.

By comparison, Phase 3 in the present invention is much longer than the prior art and the light source is switched off. In the present invention, when information is required about the ambient light level the sensor disables the navigation LED and operates in a second type of operation (e.g. as compared to the mousing operation which is a first type of operation). The sensor then operates with a long integration time in which the integration time Tᵢₙₜ is 50 μs to 100 μs. The exposure phase (Phase 3) of the present invention is preferably an integer multiple of 50 ms as this is a multiple of 50 Hz and 60 Hz and thus helps avoid flicker. The exposure phase (Phase 3) of the present invention may be over 1000 times longer than the similar phase for normal mouse operation.

The fourth phase (Phase 4) is a readout phase in which the LED is off and the ambient light is readout. The ambient light is measured by measuring the voltage on the photodiode using for example a “column parallel” single slope analog to digital converter (ADC), where a reference voltage (Vref) is generated by the digital to analog converter (DAC) and compared with the voltage on the photodiode.

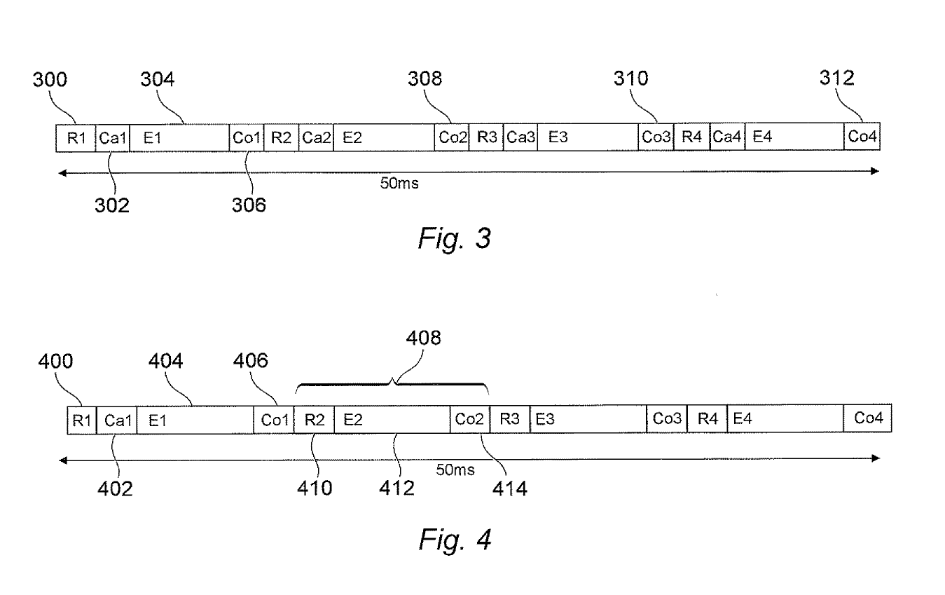

Allowing for the F-number of the imaging lens and any possible filtering in the optical path an exposure time of around 50 ms would equate to an ambient light level of 20 kLux to be measured before the pixel saturates. This time can be reduced if the pixels saturate after the end of the period in which case, multiple ADC conversions may be performed to produce the ambient level. This is shown with reference to FIG. 3. Referring to FIG. 3, a number of cycles or phases are shown. The first cycle 300 is a reset cycle, a first calibration cycle 302 then follows. A first exposure cycle 304 is then followed with the first conversion cycle 306. The output would be a combination of the conversion cycle for first, second, third and fourth iterations of the cycles (306, 308, 310, and 312). The four cycles correspond to the phases 1 to 4 respectively described above.

The reset, calibration and readout phases are typically the same time period as a conventional mouse in total adding up to approximately 60 μs. By comparison, the exposure cycle could be in the region of 12.4 ms, assuming that there are four cycles for every 50 ms. The difference between the length of the exposure cycle and the combination of the other cycles can vary from a factor of about 100 to a factor of about 1000. Clearly, other values are equally valid although it will be appreciated that the exposure cycle is many times greater than the combined other cycles and ideally an integer multiple of the time Tᵢₙₜ.

The above is described with reference to a single pixel. However, to avoid the problems of pixel-pixel mismatch and any thermally induced noise the output from individual pixels may be combined in any appropriate manner. For example, an appropriate manner may include averaging, summing or summing and truncating the data.

In an alternative embodiment of the invention it may be possible to operate the system with only one calibration phase for a multiple of other phases. This is shown in FIG. 4 and while it is a practical system it may add noise and is thus less preferred than the previous system. FIG. 4 shows a first reset cycle 400, a first calibration cycle 402, a first exposure cycle 404, and a first conversion or readout cycle 406. In the second group of phases 408 there is no calibration phase, but merely a reset cycle 410, an exposure cycle 412 and a conversion cycle 414. While this embodiment is fully operational it may require additional noise processing circuitry to overcome any additional noise levels. It will be appreciated that the number of groups of phases for a given calibration phase may vary depending on requirements.

In any of the embodiments described above, if the user has their finger or thumb on the surface of the mouse sensor, for example to move the cursor or control the operation of the mobile device, it will obscure ambient light reaching the sensor, which could give a false reading.

Optical mouse image processing (navigation) algorithms include a routine which detects if there is a surface present by analyzing the data and looking for features in the image. Hence, if the handheld device interrogated the sensor for an ambient light level, the device would firstly briefly operate as a mouse (one frame should be sufficient) to determine if there was a surface detected (i.e. finger) or not. If no surface is detected, the sensor would measure ambient light and report back the ambient light level to the handheld. If a surface is detected, the sensor could either report back to the handheld an error code (e.g. unable to make a measurement) or monitor the surface at regular intervals (e.g. 100 ms) until it detects there is no longer a surface (finger) present and then make the ambient light level reading. This surface detection feature can be enabled/disabled. The surface detection method can be performed a predetermined number of times before an error code is returned. This might be useful to prevent energy wastage in situations where a phone is in a pocket and there is constantly a surface against the phone, or similar situations.

The ambient light sensor is integrated with an optical mouse in the above described embodiments. It will be appreciated that the light sensor may be integrated with other optical pointing devices than those described specifically herein.

The pointing device of the present invention is suitable for use in any appropriate device, such as a mobile or smart telephone, other personal or communications devices, a camera or any other suitable device.

1-17. (canceled)

18. An optical pointing device comprising:
a light source configured to provide light to be detected to determine relative motion of the optical pointing device; and
a sensor configured to detect light from the light source in a first type operation to determine the relative motion, and being configured to detect ambient light in a second type operation.

19. The optical pointing device of claim 18, wherein in the second type operation the light source is disabled and the sensor measures ambient light conditions over a time period.

20. The optical pointing device of claim 19, wherein the second type operation further comprises a reset cycle, a calibration cycle, an exposure cycle during which the sensor detects the ambient light conditions, and a readout cycle.

21. The optical pointing device of claim 20, wherein a time period of the exposure cycle is between a hundred to a thousand times greater than a time period of a combination of the reset, calibration and readout cycles.

22. The optical pointing device of claim 21, wherein the time period of the exposure cycle is an integer multiple of an integration period of the sensor.

23. The optical pointing device of claim 18, further comprising control circuitry configured to determine when the first type operation is being performed and prevent switching to the second type operation during the first type operation.

24. The optical pointing device of claim 23, wherein the control circuitry is configured to repeat the determination until the first type operation is not being performed and the second type operation is initiated, or until the determination has been repeated a number of times.

25. The optical pointing device of claim 18, wherein the optical pointing device defines an optical mouse.

26. An electronic device comprising:
an optical pointing device including
a light source, and
a sensor configured to detect light from the light source in a first type operation to determine the relative motion of the optical pointing device, and being configured to detect ambient light in a second type operation.

27. The electronic device of claim 26, wherein the electronic device defines a mobile wireless telephone.

28. The electronic device of claim 26, wherein the electronic device defines a computer.

29. A method of operating an optical pointing device that includes a light source configured to provide light to be detected to determine relative motion of the optical pointing device, and a sensor, the method comprising:
operating the sensor to detect light from the light source in a first type operation to determine the relative motion; and
disabling the light source and operating the sensor to detect ambient light in a second type operation to determine ambient light conditions.

30. The method of claim 29, wherein the second type operation further comprises a reset cycle, a calibration cycle, an exposure cycle during which the sensor detects the ambient light conditions, and a readout cycle.

31. The method of claim 30, wherein a time period of the exposure cycle is between a hundred to a thousand times greater than a time period of a combination of the reset, calibration and readout cycles.

32. The method of claim 30, wherein a time period of the exposure cycle is an integer multiple of an integration period of the sensor.

33. The method of claim 29, further comprising:
requesting the second type operation; and
upon the request, determining whether the first type operation is being performed and prevent switching to the second type operation during the first type operation.

34. The method of claim 33, further comprising repeating the determination until the first type operation is not being performed and the second type operation is initiated, or until the determination has been repeated a number of times.
